(19) United States
(12) Patent Application Publication
(10) Pub. No.: US 2021/0360904 A1
(43) Pub. Date: Nov. 25, 2021

(54) ANIMAL SPECIMEN PICKING DEVICE AND SYSTEM

(71) Applicant: Tamkang University, New Taipei City (TW)

(72) Inventors: Yang-Han Lee, New Taipei City (TW); Yu-De Liao, New Taipei City (TW); Yi-Lun Chen, New Taipei City (TW)

(73) Assignee: Tamkang University, New Taipei City (TW)

(21) Appl. No.: 16/940,069

(22) Filed: Jul. 27, 2020

(30) Foreign Application Priority Data
May 20, 2020 (TW) 109116797

(51) Int. Cl. A01K 31/16; H04W 4/80

(52) U.S. Cl. CPC A01K 31/165; H04W 4/80

(57) ABSTRACT

An animal specimen picking device and system are provided. The animal specimen picking device includes a collecting device and a driving device. The collecting device includes at least one opening through which an animal specimen is collected. The driving device drives the collecting device to move on a collecting surface. The animal specimen is on the collecting surface. The driving device includes a spherical shell, a controller, and a driving module. The controller is located in the spherical shell and configured to generate a control signal. The driving module is located in the spherical shell and configured to drive the spherical shell to roll according to the control signal.

### CROSS-REFERENCE TO RELATED APPLICATION

This non-provisional application claims priority under 35 U.S.C. § 119(a) to patent application Ser. No. 10/911,6797 in Taiwan, R.O.C. on May 20, 2020, the entire contents of which are hereby incorporated by reference.

### BACKGROUND

### Technical Field

The present invention relates to a picking device, and in particular, to an animal specimen picking device and system.

### Related Art

There are many farms nowadays, and the farms provide food for people to live. Taking a laying hen farm as an example, traditional laying hen farms are mostly one-storey open buildings, there is a three-storey chicken coop inside a henhouse, and a level of mechanization is generally low. In addition to semi-automatic feed delivery, egg picking and chicken feces are mostly handled manually, and a height between the chicken coop and a partition board or the ground is usually narrow, making it difficult to collect eggs and chicken feces. In addition, mechanized feces recovery devices usually collect feces from the henhouse uniformly, and it is impossible to distinguish from which chicken coop the feces are recovered.

### SUMMARY

In view of the above, the present invention provides an animal specimen picking device and system to provide convenient and rapid collection of animal specimens. the animal specimens are classified and managed according to the corresponding regions of these animal specimens, so that when a check result of the animal specimen is abnormal, a region that is of a farm and in which an animal is in an abnormal state can be immediately known, and corresponding treatment is performed in real time.

According to some embodiments, the animal specimen picking device includes a collecting device and a driving device. The collecting device includes at least one opening through which an animal specimen is collected. The driving device drives the collecting device to move on a collecting surface. The animal specimen is on the collecting surface. The driving device includes a spherical shell, a controller, and a driving module. The controller is located in the spherical shell and configured to generate a control signal. The driving module is located in the spherical shell and configured to drive the spherical shell to roll according to the control signal.

According to some embodiments, the collecting device includes a collecting box and a traction portion. The collecting box has a chamber for accommodating the animal specimen. The at least one opening is disposed at a lower end of a side face of the collecting box to communicate with the chamber. The traction portion is connected to the collecting box and has a hemispherical groove to be buckled on the spherical shell, to cause the driving device to pull the collecting box when the driving device moves.

According to some embodiments, the collecting device includes an outer spherical shell and at least one positioning portion. The outer spherical shell covers the spherical shell of the driving device. A plurality of openings are disposed on the outer spherical shell in a dispersed manner. The positioning portion is connected between the spherical shell and the outer spherical shell, to cause the spherical shell of the driving device to be interlocked with the outer spherical shell to roll when the spherical shell rolls.

According to some embodiments, pore sizes of these openings are capable of being used for filling the animal specimen in the openings.

According to some embodiments, the outer spherical shell includes a plurality of sub-shells. The sub-shells are detachably assembled together.

According to some embodiments, an outer surface of the outer spherical shell of the collecting device has at least one convex portion.

According to some embodiments, the driving device further includes a wireless communication interface. The wireless communication interface is coupled to the controller, the controller being configured to generate the control signal in response to a control instruction received through the wireless communication interface, to control the driving device to move.

According to some embodiments, the animal specimen picking system includes an animal specimen picking device and a control host. The animal specimen picking device is placed in a region of a breeding end. The animal specimen picking device further includes a controlled-end communication interface. The controlled-end communication interface is coupled to a controller. The controlled-end communication interface is configured to receive or send a positioning signal. The control host is disposed at the breeding end. One of the control host and the animal specimen picking device performs indoor positioning on the other through the positioning signal to obtain positioning information. The control host records, according to the positioning information, that the animal specimen picking device is located in the region of the breeding end.

According to some embodiments, the animal specimen picking system further includes an environment detection module. The environment detection module detects an environment status of the region of the breeding end, and when it is detected that the environment status of the region meets a trigger condition, the control host sends a placing control signal. The controller of the animal specimen picking device generates the control signal in response to the placing control signal received through the controlled-end communication interface, to control the animal specimen picking device to move to the region, wherein the environment detection module displays the environment status of the region of the breeding end through a human-machine interface.

According to some embodiments, the animal specimen picking device further includes an environment detector. The environment detector detects an environment status of the corresponding placing region, where the controller of the animal specimen picking device displays the environment status of the corresponding placing region through a human-machine interface.

Therefore, according to some embodiments, when the driving device of the animal specimen picking device rolls, the collecting device provided with the opening is driven to collect the animal specimen on the collecting surface, so that the animal specimen located in a narrow space can be easily collected, and human resource costs are reduced. Through a positioning mechanism of the animal specimen picking system, it can be easily learned that the collected animal specimen is obtained from which region of the breeding end, so that when it is detected that the animal specimen is abnormal, subsequent treatment can be performed on the region of the breeding end corresponding to the abnormal animal specimen, such as epidemic prevention treatment (killing an animal infected with pathogens) or isolation measures.

### BRIEF DESCRIPTION OF THE DRAWINGS

FIG. 1 is a three-dimensional view of an animal specimen picking device according to an embodiment of the present invention.

FIG. 2 is a three-dimensional view of an animal specimen picking device according to another embodiment of the present invention.

FIG. 3 is a three-dimensional view of an animal specimen picking device according to still another embodiment of the present invention.

FIG. 4 is a schematic circuit block diagram of an animal specimen picking system according to an embodiment of the present invention.

FIG. 5 is a schematic diagram of an architecture of an animal specimen picking system according to an embodiment of the present invention.

### DETAILED DESCRIPTION

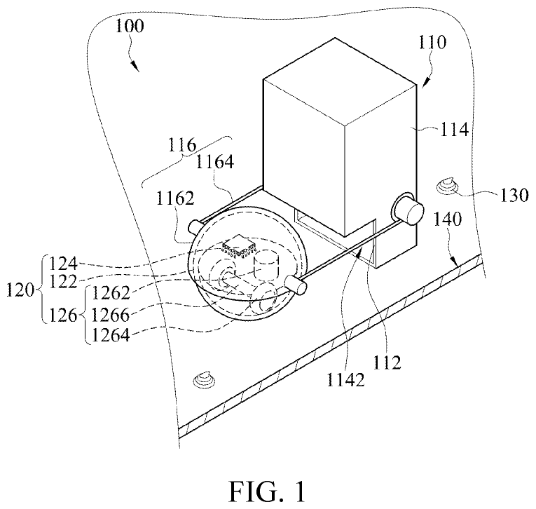

FIG. 1 is a three-dimensional view of an animal specimen picking device 100 according to an embodiment of the present invention. The animal specimen picking device 100 includes a collecting device 110 and a driving device 120. The collecting device 110 includes an opening 112 through which an animal specimen 130 is collected. The driving device 120 is connected to the collecting device 110 and drives the collecting device 110 to move on a collecting surface 140. The collecting surface 140 is a surface with the animal specimen 130, such as a ground or a bottom surface of a chicken coop, and may be a smooth flat surface or an uneven surface depending on a breeding environment. The driving device 120 includes a spherical shell 122, a controller 124, and a driving module 126. The controller 124 and the driving module 126 are located in the spherical shell 122. The controller 124 is coupled to the driving module 126 and generates a control signal and sends the control signal to the driving module 126 to actuate the driving module 126, to control a moving direction of the driving device 120.

When the driving device 120 rolls and is displaced, for example, when the driving module 126 actuates to cause the spherical shell 122 rolls on the collecting surface 140 to displace the driving device 120, the collecting device 110 can be driven to move accordingly, so that the opening 112 is in contact with the collecting surface 140. Therefore, the animal specimen 130 can be collected through the opening 112. In this way, even if the animal specimen 130 is located in a narrow space such as a passage between chicken coops in a henhouse, a passage between a chicken coop and a partition board at the bottom of the chicken coop, or a passage between a chicken coop and the ground, the animal specimen 130 can be easily collected. In addition, human resource costs can also be reduced.

The collecting device 110 may further include a collecting box 114 and a traction portion 116. The collecting box 114 has a chamber 1142 for accommodating the animal specimen 130. The opening 112 is disposed at a lower end of a side face of the collecting box 114 to communicate with the chamber 1142. The traction portion 116 includes a hemispherical groove 1162 and a connecting member 1164. The hemispherical groove 1162 is buckled on the spherical shell 122 and is connected to the collecting box 114 through the connecting member 1164, to cause the driving device 120 to pull the collecting box 114 when the driving device 120 moves, thereby pulling the collecting device 110 to move and to collect the animal specimen 130 through the opening 112 on the collecting surface 140 and accommodate the animal specimen in the chamber 1142. Herein, the connecting member 1164 is two connecting rods, and two ends of each connecting rod are respectively connected to one side of the collecting box 114 and one side of the hemispherical groove 1162. However, the present invention is not limited to this, and the connecting member 1164 may be a chain, a gear, or the like. When the driving device 120 moves and pulls the collecting box 114, the collecting device 110 is in contact with the collecting surface 140 through the bottom connected to a lower end of the opening 112, and collects the animal specimen 130 through shoveling, so that the animal specimen 130 enters the chamber 1142 through the opening 112.

In some embodiments, a plurality of openings 112 may be disposed on the collecting box 114. These openings 112 may be communicated with a same chamber 1142, or may be communicated with a plurality of chambers 1142 that are not communicated.

In some embodiments, the hemispherical groove 1162 may be buckled on one third of an outer surface of the spherical shell 122, but is not limited thereto. For example, the hemispherical groove may be buckled on a quarter outer surface or a half outer surface, provided that the hemispherical groove can be buckled on the outer surface of the spherical shell 122. In some embodiments, an outer surface or an inner surface of the hemispherical groove 1162 is not limited to a smooth curved surface, and may also have edges and corners.

In some embodiments, there is at least one fixing mechanism between the traction portion 116 and the collecting box 114, and the traction portion 116 is fixed to the collecting box 114 relative to one end of the hemispherical groove 1162 in a removable fixing manner. The removable fixing manner may be, for example, gluing, magnetic attraction, locking, or screwing. For example, the fixing mechanism is a screw and a nut that fit with each other. The screw penetrates the collecting box 114, and one end of the connecting member 1164 has a perforation to be sleeved on the screw, and fixes the hemispherical groove 1162 and the collecting box 114 through locking of the nut.

In some embodiments, after the animal specimen 130 is collected, the fixing mechanism may be disassembled to separate the traction portion 116 from the collecting box 114, so that the animal specimen 130 in the collecting box 114 can be taken out for subsequent testing. After the animal specimen 130 in the collecting box 114 is taken out, another collecting box 114 may be connected to the traction portion 116, or the used collecting box 114 may be cleaned and then connected to the traction portion 116. In this way, the animal specimen 130 can be quickly recovered, reusing is implemented, and waste of resources and materials is reduced.

In some embodiments, a body of the collecting device 110 may be a device made of a plastic material, a metal material, an elastic material, or the like. The elastic material may be a rubber, an elastic alloy, a thermoplastic elastomer, or the like. In some embodiments, a shape of the opening 112 may be rectangular, triangular, circular, irregular, or the like. In some embodiments, the animal specimen 130 may be animal feces, animal body fluids, animal urine, animal blood, or the like, but is not limited thereto. The animal specimen 130 may be solid, liquid, paste-like, or the like.

In some embodiments, the driving device 120 may be a ball robot. The spherical shell 122 may be made of a plastic material, a metal material, an elastic material, or the like. The elastic material may be a rubber, an elastic alloy, a thermoplastic elastomer, or the like. The spherical shell 122 may be a spherical body or a shell with a polygon close to a sphere. The controller 124 is, for example but not limited to, a central processing unit (CPU), a microprocessor, an application-specific integrated circuit (ASIC), or a system on a chip (SOC).

The driving module 126 may be implemented by a motor 1262 and a roller 1264 to drive the spherical shell 122 to roll. In particular, the roller 1264 is pressed against the spherical shell 122, and the motor 1262 is connected to the roller 1264 through an output shaft 1266. After the motor is actuated according to a control signal, the roller 1264 is caused to roll through the output shaft 1266, and then the spherical shell 122 is driven to roll. Therefore, the driving device 120 is displaced. The motor 1262 may be a stepper motor, a direct current motor, an alternating current motor, a pulse motor, a synchronous motor, or the like, but it is not limited thereto. In some embodiments, the driving module 126 drives a rolling direction of the spherical shell 122 according to the control signal. For example, according to the control signal, one roller 1264 rotates faster than another roller wheel 1264, so that the spherical shell 122 is rolled in a direction driven by the roller 1264 having a faster rotation rate. In some embodiments, the driving module 126 may further include an elastic component to assist the roller 1264 to press against the spherical shell 122. The elastic component may be a component made of an elastic material. The elastic material is, for example but not limited to, a rubber material, a polyisoprene, a synthetic polyisoprene rubber, or a butyl rubber.

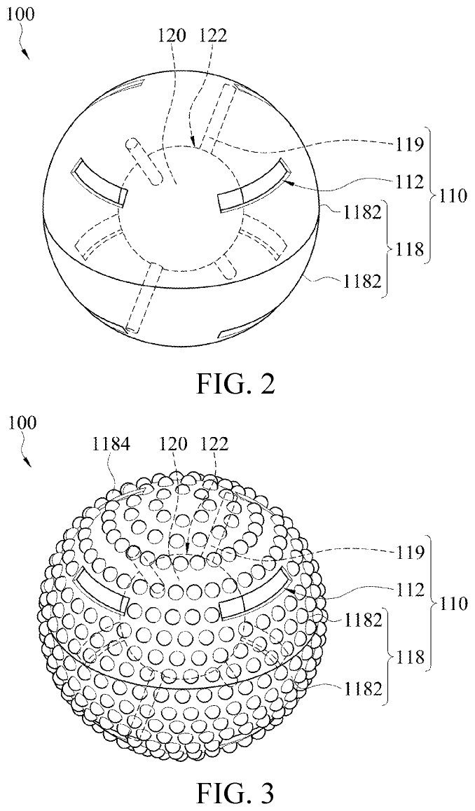

FIG. 2 is a three-dimensional view of an animal specimen picking device 100 according to another embodiment of the present invention. The collecting device 110 includes an outer spherical shell 118 and at least one positioning portion 119. The outer spherical shell 118 covers the spherical shell 122 of the driving device 120. A plurality of openings 112 are disposed on the outer spherical shell 118 in a dispersed manner. The positioning portion 119 is connected between the spherical shell 122 and the outer spherical shell 118, to cause the spherical shell 122 of the driving device 120 to be interlocked with the outer spherical shell 118 to roll when the spherical shell rolls. Herein, the positioning portion 119 has a column shape, but the present invention is not limited thereto.

In some embodiments, the outer surface of the spherical shell 122 and an inner surface of the outer spherical shell 118 are respectively provided with grooves corresponding to the positioning portion 119 for the positioning portion 119 to be inserted into the grooves. In some embodiments, an outer surface or an inner surface of the outer spherical shell 118 is not limited to a smooth curved surface, and may also have edges and corners. In some embodiments, a shape of the outer spherical shell 118 is the same as a shape of the spherical shell 122. However, in some embodiments, the shape of the outer spherical shell 118 is different from the shape of the spherical shell 122. For example, the spherical shell 122 is a polygon close to a sphere, and the outer spherical shell 118 is a round sphere.

In some embodiments, a pore size of the opening 112 of the outer spherical shell 118 is capable of being used for filling the animal specimen 130 in the opening. The animal specimen 130 may be a paste such as chicken feces, when the spherical shell 122 of the driving device 120 is interlocked with the outer spherical shell 118 to roll, the spherical shell rolls on the collecting surface 140, so that the animal specimen 130 is filled in the opening 112 through squeezing.

In some embodiments, the outer spherical shell 118 includes a plurality of sub-shells 1182, the sub-shells 1182 being detachably assembled together. For example, the sub-shells 1182 are two hemispherical shells, and each has a corresponding rotating screw thread. Therefore, the outer hemispherical shell 118 may be formed by rotating and combining the two hemispherical shells through the corresponding screw threads. In some embodiments, the outer spherical shell 118 further includes at least one assembling component, and the sub-shells 1182 are assembled to form the outer spherical shell 118 through the assembling component. The assembling component may be a component implemented gluing, magnetic attraction, locking, screwing, clamping, or the like. Two sub-shells 1182 are used as an example for description. For example, the assembling component may be a hook and a slot corresponding to the hook. One sub-shell 1182 has the hook, the other sub-shell 1182 has the slot, and the sub-shells 1182 are assembled to form the outer spherical shell 118 by clamping the hook to the slot. Disassembling and assembling of the sub-housing 1182 make it easier to replace the driving device 120 and recover the animal specimen 130. For example, only a new outer spherical shell 118 needs to be replaced, or the outer spherical shell 118 on which the animal specimen 130 is recovered and cleaned is reconnected to the spherical shell 122 through the positioning portion 119, so that the animal specimen 130 can be recollected on the collecting surface 140.

In some embodiments, the collecting device 110 may not include the positioning portion 119, that is, the outer spherical shell 118 is directly sleeved on and covers the spherical shell 122, so that when the spherical shell 122 of the driving device 120 rolls, the outer spherical shell 118 also rolls accordingly. Herein, the outer spherical shell 118 may be made of a soft material, such as silicone, which is conducive to close contact with the spherical shell 122. The outer spherical shell 118 can also be made of a material with a large friction coefficient, which is conducive to increasing of friction to facilitate rolling. The outer spherical shell 118 may be made of a soft material and covers the spherical shell 122. Therefore, the outer spherical shell 118 may be changed in shape according to a shape of the spherical shell 122 of the driving device 120.

FIG. 3 is a three-dimensional view of an animal specimen picking device 100 according to still another embodiment of the present invention. An outer surface of the outer spherical shell 118 of the collecting device 110 has at least one convex portion 1184, to increase friction when the outer spherical shell moves on the collecting surface 140. The convex portion 1184 may be a convex portion of any shape, such as a circle or a triangle, but is not limited thereto. The convex portion 1184 may be made of a metal material, a plastic material, or the like.

In some embodiments, the driving device 120 further includes a wireless communication interface. The wireless communication interface is coupled to the controller 124, the controller 124 being configured to generate the control signal in response to a control instruction received through the wireless communication interface, to control the driving device 120 to move. For example, the wireless communication interface receives the control instruction from a user device, and the controller 124 responds to the control instruction and generates the control signal to control a moving direction of the driving device 120. The wireless communication interface may provide a short-range communication function, for example but not limited to, a wireless transmission communication interface, such as Bluetooth, a wireless hotspot, mobile communication, or near field communication (NFC), or provide a network communication service and perform communication through a network. The user device is, for example but not limited to, a mobile phone, a personal digital assistant (PDA), a notebook computer, or a desktop computer.

In some embodiments, the animal specimen picking device 100 further includes one or more environment detectors configured to detect a status of an external environment, such as an environment status of a henhouse or a farm. For example, the environment detector may be a temperature sensor configured to detect a temperature of the henhouse or the farm, the environment detector may be a humidity sensor configured to detect humidity of the henhouse or the farm, the environment detector may be a wind direction sensor configured to detect a wind direction of the henhouse or the farm, the environment detector may be a wind speed sensor configured to detect a wind speed of the henhouse or the farm, the environment detector may be a light sensor configured to detect a light intensity of the henhouse or the farm, or the environment detector may be an ammonia sensor configured to detect an ammonia concentration of the henhouse or the farm, but is not limited thereto.

In some embodiments, the driving device 120 further includes an angle measurement module. The angle measurement module is coupled to the controller 124. The angle measurement module measures a rotation angle of the driving device 120 when the driving device rolls, and the controller 124 adjusts a rolling angle of the driving device 120 according to the rotation angle to balance the driving module 126, so that the driving device 120 can roll in a balanced manner. The angle measurement module is, for example but not limited to, a mechanical gyroscope, a fiber optic gyroscope, a laser resonance gyroscope, an integrated vibratory gyroscope, a microelectromechanical gyroscope, or an angular velocity sensor. In some embodiments, the driving device 120 further includes a camera device configured to capture an image outside the driving device 120. In some embodiments, the driving device 120 further includes a circuit board for connection with the controller 124, the driving module 126, the wireless communication interface, the environment detector, the angle measurement module, the camera device, and the like.

In order to facilitate description of the animal specimen picking system, the wireless communication interface of the animal specimen picking device 100 is referred to as a controlled-end communication interface 128 below.

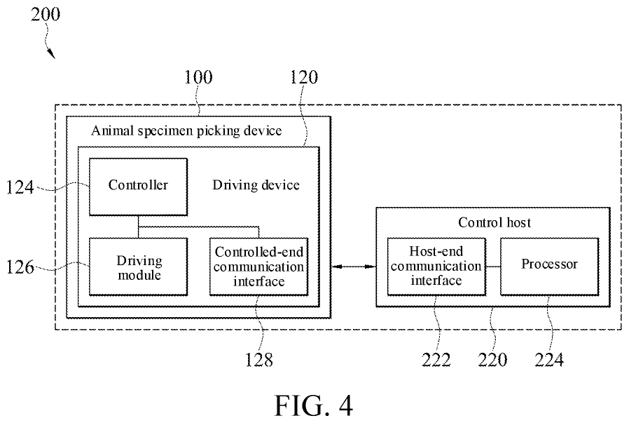

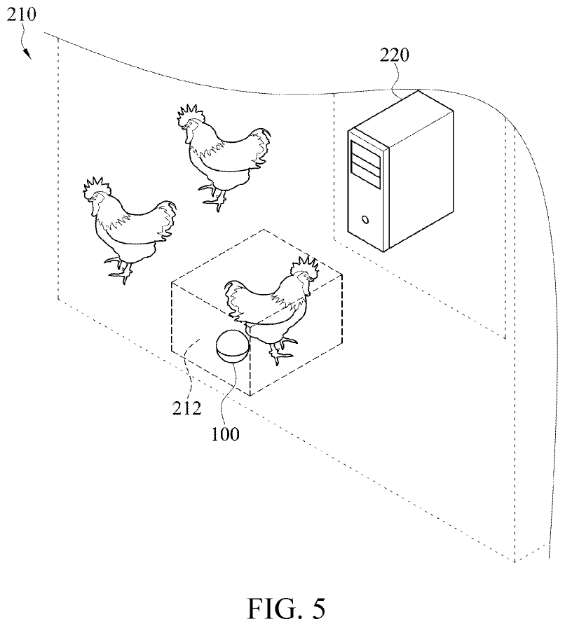

Referring to FIG. 1 to FIG. 5, FIG. 4 is a schematic circuit block diagram of an animal specimen picking system 200 according to an embodiment of the present invention. FIG. 5 is a schematic diagram of an architecture of an animal specimen picking system 200 according to an embodiment of the present invention. The animal specimen picking system 200 includes an animal specimen picking device 100 and a control host 220. The animal specimen picking device 100 is placed in a region 212 of a breeding end 210. The breeding end 210 may be a farm. The breeding end 210 may have one or more regions 212. The control host 220 is disposed at the breeding end 210. The control host 220 includes a host-end communication interface 222 and a processor 224. The processor 224 is coupled to the host-end communication interface 222.

Indoor positioning of the animal specimen picking device 100 of the animal specimen picking system 200 may be implemented through calculation by the animal specimen picking device 100 or the control host 220. Herein, a case in which indoor positioning is implemented through calculation by the animal specimen picking device 100 is used for description. The controlled-end communication interface 128 of the animal specimen picking device 100 receives a positioning signal. In some embodiments, the positioning signal may be a wireless broadcast signal, such as a Wi-Fi broadcast signal or a Bluetooth beacon signal. After the controlled-end communication interface 128 receives the positioning signal, the controller 124 performs indoor positioning. For example, the controller performs positioning of an angle of departure (AoD) and performs in-phase and quadrature-phase sampling, that is, sampling of an in-phase quadrature-phase (IQ) value, calculates a position of the animal specimen picking device 100 at the breeding end 210 according to the IQ value, generates positioning information, and transmits the positioning information to the control host 220 through the controlled-end communication interface 128. Herein, the positioning signal may be sent by the control host 220, the user device, or one or more beacon devices, and these devices have an antenna group that supports angle detection, so that the animal specimen picking device 100 can perform positioning of the AoD. In some embodiments, the controller 124 and the controlled-end communication interface 128 of the animal specimen picking device 100 may calculate a position of the animal specimen picking device 100 according to an indoor positioning technology that meets a guideline of Bluetooth 5.1 or a version earlier than Bluetooth 5.1.

In some embodiments, the positioning information may include relative coordinates of the animal specimen picking device 100 at the breeding end 210, absolute coordinates of the animal specimen picking device 100 (such as latitude and longitude coordinates), a phase or quadrature phase of an angle of arrival (AoA) or an AoD of the positioning signal. The relative coordinates may be coordinates of the animal specimen picking device 100 relative to the control host 220, the user device, and the beacon device. Therefore, according to the positioning information, it can be learned that the animal specimen picking device 100 is located in which region 212 of the breeding end 210.

In some embodiments, the controller 124 performs triangulation according to the positioning signal to generate the positioning information. For example, the controller 124 calculates a distance between the animal specimen picking device 100 and the beacon device according to an attenuation degree of a received signal strength indicator (RSSI) of the positioning signal, and obtains coordinates of the animal specimen picking device 100 through triangulation to generate the positioning information.

Herein, a case in which indoor positioning is implemented through calculation by the control host 220 is used for description. The controlled-end communication interface 128 of the animal specimen picking device 100 sends the positioning signal, the host-end communication interface 222 of the control host 220 receives the positioning signal, and the processor 224 performs indoor positioning. For example, the processor performs positioning of AoA and performs in-phase and quadrature-phase sampling, that is, sampling of an IQ value, calculates a position of the animal specimen picking device 100 at the breeding end 210 according to the IQ value, and generates positioning information. For example, the processor 224 performs a triangle positioning operation according to the IQ value to obtain relative coordinates or absolute coordinates of the animal specimen picking device 100 at the breeding end 210. Herein, the host-end communication interface 222 may be an antenna group including a plurality of antennas.

In some embodiments, the processor 224 and the host-end communication interface 222 of the control host 220 may calculate a position of the animal specimen picking device 100 according to an indoor positioning technology that meets a guideline of Bluetooth 5.1 or a version earlier than Bluetooth 5.1.

In some embodiments, a plurality of beacon devices may receive the positioning signal, and the processor 224 of the control host 220 performs positioning of AoA through the beacon device to generate an AoA parameter, and the processor 224 calculates the position of the animal specimen picking device 100 according to the AoA parameter to generate the positioning information.

The processor 224 records information about the region 212 of the animal specimen picking device 100 at the breeding end 210 in a memory device according to the positioning information. The memory device is configured to store the information. The memory device is, for example but not limited to, a solid state hard disk or a random access memory (RAM). For example, the processor 224 parses the positioning information to obtain the position of the animal specimen picking device 100 at the breeding end 210, that is, to obtain a positioning result indicating the animal specimen picking device 100 is located in which region 212 of the plurality of regions 212 at the breeding end 210, and stores the positioning result in the memory device. Therefore, when the animal specimen picking device 100 collects the animal specimen 130, a farmer can know the placing region 212 corresponding to the animal specimen picking device 100 through the positioning result, and then know the animal specimen 130 is collected from which region 212 of the breeding end 210, so that when it is detected that the animal specimen 130 is abnormal, subsequent treatment can be performed on the region 212 of the breeding end 210 corresponding to the abnormal animal specimen 130, such as epidemic prevention treatment (killing an animal infected with pathogens) or isolation measures.

The processor 224 is, for example but not limited to, a central processing unit (CPU), a microprocessor, an application-specific integrated circuit (ASIC), or a system on a chip (SOC). The host-end communication interface 222 may provide a short-range communication function, for example but not limited to, a wireless transmission communication interface, such as Bluetooth, a wireless hotspot, mobile communication, or near field communication (NFC), or provide a network communication service and communicate with another device through a network.

In some embodiments, the animal specimen picking system 200 includes one or more animal specimen picking devices 100 and one or more control hosts 220. In some embodiments, the positioning result generated by the processor 224 may be transmitted to a cloud server or the user device. In some embodiments, the control host 220 may further include a wired communication interface to provide a network communication service, for example but not limited to, Ethernet.

In some embodiments, the animal specimen picking system 200 further includes an environment detection module. The environment detection module detects an environment status of the region 212 of the breeding end 210, and when detecting that the environment status of the region 212 meets a trigger condition, the environment detection module sends an environment signal. The processor 224 of the control host 220 responds to the environment signal and sends a placing control signal through the host-end communication interface 222. The triggering condition may be that the environment status of the region 212 of the breeding end 210 is in an abnormal state, and the abnormal state may be an excessively high temperature, excessively high humidity, or an excessively high ammonia concentration. The controller 124 of the animal specimen picking device 100 generates the control signal in response to the placing control signal received through the controlled-end communication interface 128, to control the animal specimen picking device 100 to move to the region 212, wherein the environment detection module displays the environment status of the region of the breeding end 210 through a human-machine interface. Therefore, when the environment status of the region 212 is abnormal, the animal specimen picking device 100 may be placed in the region 212 with the abnormal environment status in real time to collect the animal specimen 130. When it is detected that the animal specimen 130 is abnormal, for example, ammonia content in the animal specimen 130 is too high, subsequent anti-epidemic and isolation measures are taken immediately. In addition, a farmer may monitor an environment status of the breeding end 210 in real time through the human-machine interface.

The environment detection module is, for example but not limited to, a temperature sensor, a humidity sensor, a wind direction sensor, a wind speed sensor, a light sensor, an ammonia sensor, or an integrated sensor integrating the foregoing sensors. The foregoing sensors respectively detect a temperature, humidity, a wind direction, a wind a speed, a light intensity, and an ammonia concentration of the region 212 of the breeding end 210. The foregoing trigger conditions may include that a temperature of the region 212 of the breeding end 210 exceeds a default threshold or exceeds a temperature suitable for growth of an animal at the breeding end 210; humidity exceeds a preset threshold or exceeds humidity suitable for the growth of the animal at the breeding end 210; a wind direction deviates from a preset direction or deviates from a wind direction suitable for the growth of the animal at the breeding end 210; a wind speed exceeds a preset threshold or exceeds a wind speed suitable for the growth of the animal at the breeding end 210; a light intensity exceeds a preset threshold or exceeds a light intensity suitable for the growth of the animal at the breeding end 210; an ammonia concentration exceeds a preset threshold or exceeds an ammonia concentration suitable for the growth of the animal at the breeding end 210, and the like. In some embodiments, when at least one of the triggering conditions is met, the processor 224 of the control host 220 sends the placing control signal through the host-end communication interface 222. In some embodiments, the environment detection module may be disposed on the control host 220 and coupled to the processor 224.

In some embodiments, the human-machine interface may be a display interface including a liquid crystal screen, a touch screen, and the like. In some embodiments, the human-machine interface may be disposed on the control host 220, the user device, or the animal specimen picking device 100. In some embodiments, the user device may send the placing control signal. The user device may send the placing control signal through the control host 220, or the user device may send a placing control instruction to the control host 220 through the cloud server, and the control host 220 may respond to the placing control instruction to send the placing control signal.

In some embodiments, the environment detector of the animal specimen picking device 100 detects an environment status of the corresponding placing region 212, wherein the controller 124 of the animal specimen picking device 100 displays the environment status of the corresponding placing region 212 through a human-machine interface.

In some embodiments, the animal specimen picking system 200 may further include an action mass spectrometer disposed at the breeding end 210, so that the animal specimen 130 collected by the animal specimen picking device 100 can be immediately checked at the breeding end 210, and when a checking result is abnormal, anti-epidemic or isolation measures are quickly taken to separate an infected animal from a healthy animal, thereby avoiding comprehensive pollution of the breeding end 210.

In some embodiments, the animal specimen picking system 200 may further include a detection platform configured to quickly check the animal specimen 130. For example, when a result of detecting the animal specimen 130 by the action mass spectrometer is normal, a pigment, a pesticide, a plasticizer, an antibiotic, a residual veterinary drug, and the like of the animal specimen 130 are detected through the detection platform. When the result is abnormal, anti-epidemic or isolation measures are quickly taken.

In some embodiments, the animal specimen picking system 200 may further include an infection prediction module configured to predict and evaluate an infection risk of an animal at the breeding end 210. For example, the result is obtained by checking the animal specimen 130 by the action mass spectrometer and the detection platform, and a probability of animal infection is determined through machine learning. For example, if the result obtained by checking the animal specimen 130 shows that ammonia content is close to an upper limit of normal content in an animal, a probability of animal infection is higher.

Therefore, according to some embodiments, when the driving device of the animal specimen picking device rolls, the collecting device provided with the opening is driven to collect the animal specimen on the collecting surface, so that the animal specimen located in a narrow space can be easily collected, and human resource costs are reduced. Through a positioning mechanism of the animal specimen picking system, it can be easily learned that the collected animal specimen is obtained from which region of the breeding end, so that when it is detected that the animal specimen is abnormal, subsequent treatment can be performed on the region of the breeding end corresponding to the abnormal animal specimen, such as epidemic prevention treatment (killing an animal infected with pathogens) or isolation measures.

What is claimed is:

1. An animal specimen picking device, comprising:
a collecting device comprising at least one opening through which an animal specimen is collected; and
a driving device configured to drive the collecting device to move on a collecting surface, wherein the animal specimen is on the collecting surface, and the driving device comprises:
a spherical shell;
a controller located in the spherical shell and configured to generate a control signal; and
a driving module located in the spherical shell and configured to drive the spherical shell to roll according to the control signal.

2. The animal specimen picking device according to claim 1, wherein the collecting device comprises:
a collecting box having a chamber for accommodating the animal specimen, the at least one opening being disposed at a lower end of a side face of the collecting box to communicate with the chamber; and
a traction portion connected to the collecting box and having a hemispherical groove to be buckled on the spherical shell, to cause the driving device to pull the collecting box when the driving device moves.

3. The animal specimen picking device according to claim 1, wherein the collecting device comprises:
an outer spherical shell covering the spherical shell of the driving device, a plurality of openings being disposed on the outer spherical shell in a dispersed manner; and
at least one positioning portion connected between the spherical shell and the outer spherical shell, to cause the spherical shell of the driving device to be interlocked with the outer spherical shell to roll when the spherical shell rolls.

4. The animal specimen picking device according to claim 3, wherein pore sizes of these openings are capable of being used for filling the animal specimen in the openings.

5. The animal specimen picking device according to claim 4, wherein an outer surface of the outer spherical shell of the collecting device has at least one convex portion.

6. The animal specimen picking device according to claim 4, wherein the driving device further comprises a wireless communication interface coupled to the controller, the controller being configured to generate the control signal in response to a control instruction received through the wireless communication interface, to control the driving device to move.

7. The animal specimen picking device according to claim 3, wherein an outer surface of the outer spherical shell of the collecting device has at least one convex portion.

8. The animal specimen picking device according to claim 3, wherein the driving device further comprises a wireless communication interface coupled to the controller, the controller being configured to generate the control signal in response to a control instruction received through the wireless communication interface, to control the driving device to move.

9. The animal specimen picking device according to claim 3, wherein the outer spherical shell comprises a plurality of sub-shells, the sub-shells being detachably assembled together.

10. The animal specimen picking device according to claim 9, wherein an outer surface of the outer spherical shell of the collecting device has at least one convex portion.

11. The animal specimen picking device according to claim 9, wherein the driving device further comprises a wireless communication interface coupled to the controller, the controller being configured to generate the control signal in response to a control instruction received through the wireless communication interface, to control the driving device to move.

12. The animal specimen picking device according to claim 2, wherein the driving device further comprises a wireless communication interface coupled to the controller, the controller being configured to generate the control signal in response to a control instruction received through the wireless communication interface, to control the driving device to move.

13. The animal specimen picking device according to claim 1, wherein the driving device further comprises a wireless communication interface coupled to the controller, the controller being configured to generate the control signal in response to a control instruction received through the wireless communication interface, to control the driving device to move.

14. An animal specimen picking system, comprising:
an animal specimen picking device, placed in a region of a breeding end, comprises:
a collecting device comprising at least one opening through which an animal specimen is collected;
a driving device configured to drive the collecting device to move on a collecting surface, wherein the animal specimen is on the collecting surface, and the driving device comprises:
a spherical shell;
a controller located in the spherical shell and configured to generate a control signal; and
a driving module located in the spherical shell and configured to drive the spherical shell to roll according to the control signal; and
a controlled-end communication interface coupled to the controller to receive or send a positioning signal; and
a control host disposed at the breeding end, one of the control host and the animal specimen picking device being configured to perform indoor positioning on the other through the positioning signal to obtain positioning information, and the control host being configured to record, according to the positioning information, that the animal specimen picking device is located in the region of the breeding end.

15. The animal specimen picking system according to claim 14, wherein the collecting device comprises:
a collecting box having a chamber for accommodating the animal specimen, the at least one opening being disposed at a lower end of a side face of the collecting box to communicate with the chamber; and
a traction portion connected to the collecting box and having a hemispherical groove to be buckled on the spherical shell, to cause the driving device to pull the collecting box when the driving device moves.

16. The animal specimen picking system according to claim 14, wherein the collecting device comprises:
an outer spherical shell covering the spherical shell of the driving device, a plurality of openings being disposed on the outer spherical shell in a dispersed manner; and
at least one positioning portion connected between the spherical shell and the outer spherical shell, to cause the spherical shell of the driving device to be interlocked with the outer spherical shell to roll when the spherical shell rolls.

17. The animal specimen picking system according to claim 16, wherein pore sizes of these openings are capable of being used for filling the animal specimen in the openings.

18. The animal specimen picking system according to claim 16, wherein the outer spherical shell comprises a plurality of sub-shells, the sub-shells being detachably assembled together.

19. The animal specimen picking system according to claim 14, further comprising an environment detection module configured to detect an environment status of the region of the breeding end, when it is detected that the environment status of the region meets a trigger condition, the control host sending a placing control signal, and the controller of the animal specimen picking device generating the control signal in response to the placing control signal received through the controlled-end communication interface, to control the animal specimen picking device to move to the region, wherein the environment detection module displays the environment status of the region of the breeding end through a human-machine interface.

20. The animal specimen picking system according to claim 14, wherein the animal specimen picking device further comprises an environment detector configured to detect an environment status of the corresponding placing region, wherein the controller of the animal specimen picking device displays the environment status of the corresponding placing region through a human-machine interface.
